(19) United States
(12) Patent Application Publication
(10) Pub. No.: US 2016/0252055 A1
(43) Pub. Date: Sep. 1, 2016

(54) SELF CLEANING EXHAUST GAS RECIRCULATION COOLER SYSTEM FOR LOCOMOTIVE ENGINES

(71) Applicant: Electro-Motive Diesel, Inc., LaGrange, IL (US)

(72) Inventor: Adarsh Gopinathan Nair, Darien, IL (US)

(73) Assignee: Electro-Motive Diesel, Inc., LaGrange, IL (US)

(21) Appl. No.: 15/149,625

(22) Filed: May 9, 2016

(51) Int. Cl. F02M 26/64; F02D 41/00; F02M 26/30; F02M 26/35; F02M 26/16; F02M 26/21

(52) U.S. Cl. CPC F02M 26/64; F02M 26/16; F02M 26/21; F02M 26/30; F02M 26/35; F02D 41/0055

(57) ABSTRACT

A self-cleaning exhaust gas recirculation (EGR) cooler system of an engine is disclosed. The self-cleaning EGR cooler system includes an exhaust gas recirculation cooler, a controller, a four-way valve, and a three-way valve. The EGR cooler is disposed downstream of an exhaust manifold. The four-way valve is positioned between the exhaust manifold and the EGR cooler. The three-way valve is positioned between the EGR cooler and an intake air conduit. The controller selectively operates the four-way valve, and the three-way valve, which in operates the EGR cooler, to work in a normal flow state and a reverse flow state based on a current throttle position. Particulate matter deposited at the second end of the EGR cooler during the normal flow state, is removed by an exhaust stream entering from the second end during the reverse flow state and vice versa.

### TECHNICAL FIELD

The present disclosure generally relates to fouling in exhaust gas recirculation (EGR) systems for locomotive engines. More particularly, the present disclosure relates to cleaning of fouled EGR cooler system associated with a locomotive engine without having to remove the EGR cooler system from service.

### BACKGROUND

Recently promulgated emissions standards require a considerable reduction in particulate matter emissions along with nitrogen oxides (NOₓ) emissions. To comply with this, locomotive manufacturers have developed different strategies to cut down undesirable exhaust emissions from locomotives employed with diesel engines. Exhaust gas recirculation (EGR) system is commonly used to control the generation of undesirable pollutant gases and particulate matter during a combustion process of the diesel engines. The combustion process occurs in engine cylinders and result in production of high-temperature exhaust gas, which includes the particulate matter and NOₓ emissions. The exhaust gas, upon being expelled from the engine cylinders, flow to an exhaust manifold. Thereafter, the exhaust gas flows to the EGR system, which is provided downstream of the exhaust manifold. The EGR system primarily operates by recirculating the exhaust gas to the engine cylinders. Prior to recirculation, the exhaust gas at high temperature needs to be cooled to check NOₓ generation in the engine cylinders during the combustion process. Hence, the exhaust gas is navigated to flow through an EGR cooler. However, when the exhaust gas passes through the EGR cooler, the particulate matter present in the exhaust gas is deposited on a cooling surface of the EGR cooler over a period. This deposit may decrease efficiency of the EGR cooler. Typically, the EGR cooler is periodically removed and cleaned via high-pressure water jets. However, this method may be ineffective and may increase the down time of the machine during servicing of the EGR system.

U.S. Pat. No. 7,950,376 discloses a method to solve the problem of fouling in an EGR system. The method includes a step to reverse the flow of EGR gases that pass through an EGR cooler. The reversing of the flow of EGR gases is a part of the cleaning step, which is triggered based on the temperature feedback and/or pressure feedback from the temperature sensor and/or pressure sensor. Since the engine temperature is dependent on the EGR cooler out temperature, this invention allows the cooler to foul and then tries to mitigate it. This means that the effectiveness of the cooler is allowed to reduce over a period and then try to regenerate it. The flow reversal in this invention is dependent on the temperature out of a fouled cooler. Also, allowing the EGR cooler to foul in this invention over a period of time increases the backpressure and temperatures of the engine deteriorating the performance of the engine. Also, if the pressure sensor and/or temperature sensor fail during the engine operation, the proposed method fails to reverse the flow. A failure to reverse the flow results in increased fouling at a given location. Further, in locomotive applications, where temperatures and pressures in the system are substantially higher, and hence, it may not be reliable to use the temperature feedback and/or pressure feedback to reverse the flow. In addition, in the locomotive application, the temperature of the engine varies according to the altitude and ambient conditions. Therefore, a controller set for exhaust gas flow reversal at lower altitudes may not trigger the exhaust gas flow reversal at higher altitudes correctly and vice versa. Hence, there is a need for an improved and efficient system to mitigate fouling in the EGR cooler systems in the locomotive application.

### SUMMARY OF THE INVENTION

Various aspects of the present disclosure are directed towards a self-cleaning exhaust gas recirculation (EGR) cooler system for speed and power specific applications like a locomotive engine. The self-cleaning EGR cooler system includes an EGR cooler, a four-way valve, a three-way valve, and a controller. The EGR cooler is disposed downstream of an exhaust manifold. The EGR cooler includes a first end and a second end. The first end and the second end allow an entry of an exhaust stream into the EGR cooler in the normal flow state and the reverse flow state, respectively. The four-way valve is positioned between the exhaust manifold and the EGR cooler. The four-way valve is operable to work in the normal flow state and the reverse flow state. The four-way valve includes a first port, a second port, a third port, and a fourth port. The first port is fluidly connected to the exhaust manifold to receive the exhaust stream. The first port is selectively in fluid communication with the second port and the third port. The third port is selectively in fluid communication with the first port and the fourth port. The fourth port is fluidly connected to an intake air conduit. The three-way valve is positioned between the EGR cooler and the intake air conduit. The three-way valve is disposed downstream of the EGR cooler and upstream of the intake air conduit. The three-way valve is operable to work in the normal flow state and the reverse flow state. The three-way valve includes a first valve port, an inlet port, and an outlet port. The first valve port is in fluid communication with the second end of the EGR cooler. The first valve port is selectively in fluid connection with the inlet port and the outlet port. The inlet port is in fluid communication with the second port of the four-way valve. The outlet port is in fluid communication with the intake air conduit. The controller is in control communication with the four-way valve and the three-way valve. The controller operates the four-way valve and the three-way valve to work in a normal flow state and a reverse flow state based on a current throttle position of the engine. Such an operation of the four-way valve and the three-way valve corresponds to operate the EGR cooler in the normal flow state and the reverse flow state. Reversal of flow state may be performed based on the current throttle position, which may be one of various engine throttle positions. In the normal flow state, the exhaust stream from the exhaust manifold flows through the first port and the third port of the four-way valve. The exhaust stream then enters the EGR cooler via the first end and exits through the second end, thereby resulting in a higher particulate matter deposit at the second end. The exhaust stream downstream of the EGR cooler enters the three-way valve, via the first valve port and exits, via the outlet port and flows to the intake air conduit. In the reverse flow state, the exhaust stream from the exhaust manifold flows through the first port and the second port of the four-way valve. The exhaust stream navigates to the inlet port and exits, via the first valve port of the three-way valve. Thereafter, the exhaust stream enters the second end thereby removing the particulate matter deposit at the second end, and exits via the first end. The exited exhaust stream is navigated to the intake air conduit via the third port and fourth port of the four-way valve.

### BRIEF DESCRIPTION OF THE DRAWINGS

FIG. 1 illustrates a schematic of a locomotive engine system including an exhaust gas recirculation (EGR) system and a locomotive engine, in accordance with the concepts of the present disclosure;

FIG. 2 is a schematic of a first embodiment of an EGR cooler system of the locomotive engine system of FIG. 1, in accordance with the concepts of the present disclosure; and

FIG. 3 is a schematic of a second embodiment of the EGR cooler system of FIG. 2, in accordance with the concepts of the present disclosure.

### DETAILED DESCRIPTION

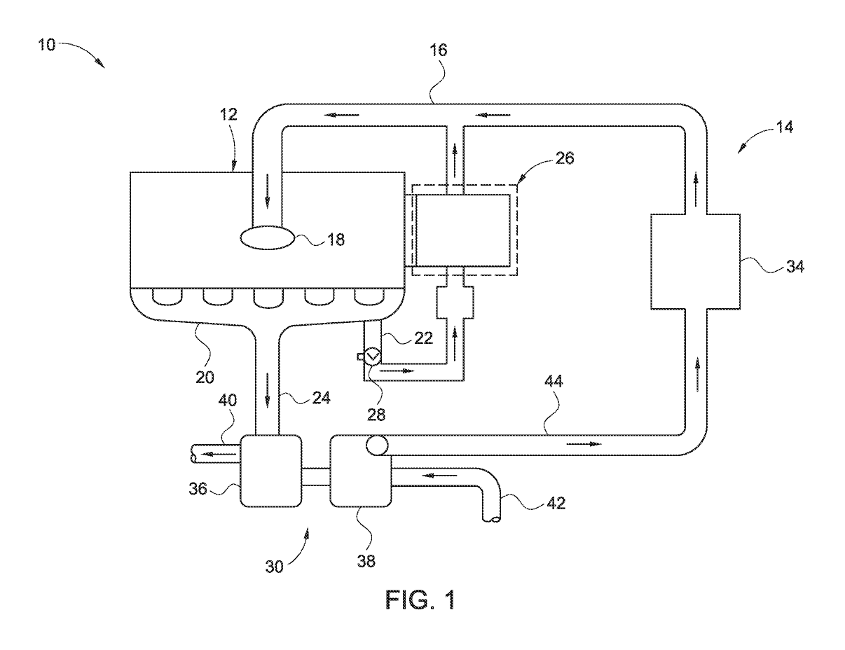

Referring to FIG. 1 there is shown a schematic representation of a locomotive engine system 10. The locomotive engine system 10 includes a locomotive engine 12 and an exhaust recirculation (EGR) system 14. The locomotive engine 12 may be a turbocharged compression ignition engine (or a diesel engine). As seen therein, the locomotive engine 12 includes an intake air conduit 16, an intake manifold 18, a plurality of cylinders (not shown), and an exhaust manifold 20.

The intake air conduit 16 is structured to supply air from an environment. The intake air conduit 16 is fluidly connected to the intake manifold 18 The intake manifold 18 receives the air from the intake air conduit 16. The intake manifold 18 is in fluidly connected and positioned upstream to the cylinders (not shown).

The cylinders (not shown) include combustion chambers, where fuel is injected in a compressed air and is combusted during operation. Each cylinder (not shown) receives the air from the intake manifold 18. Each cylinder (not shown) is also in fluid communication with the exhaust manifold 20. The exhaust manifold 20 is positioned downstream of the cylinders (not shown) and receives exhaust stream upon combustion in the cylinders (not shown). A portion of the exhaust stream exits the exhaust manifold 20 and flows to the EGR system 14.

The EGR system 14 generally includes a first EGR conduit 22, a second EGR conduit 24, a self-cleaning EGR cooler system 26 (hereinafter, referred to as the EGR cooler system 26), and an EGR valve 28.

As shown in FIG. 1, the first EGR conduit 22 is disposed downstream of the exhaust manifold 20. The first EGR conduit 22 is in fluid communication with the exhaust manifold 20 and is adapted for diverting a flow of the exhaust gas from the exhaust manifold 20 to a position downstream of the EGR cooler system 26. The diverted flow of the exhaust gas from the exhaust manifold 20, via the first EGR conduit 22 is controlled using the EGR valve 28.

The EGR valve 28 is positioned upstream of the EGR cooler system 26. Alternatively, the EGR valve 28 may be positioned downstream of the EGR cooler system 26. The EGR valve 28 meters an amount of the exhaust gas re-circulated to the intake manifold 18.

The EGR cooler system 26 is disposed upstream of the intake manifold 18. The EGR cooler system 26 receives the metered amount of exhaust gas from the EGR valve 28. The EGR cooler system 26 is adapted to cool the received exhaust gas and deliver the cooled exhaust gas to the intake manifold 18, via the intake air conduit 16. The structure and operation of the EGR cooler system 26 is explained in detail further in the description.

The locomotive engine system 10 also includes a turbocharger 30 and an aftercooler 34. The turbocharger 30 receives a portion of the exhaust gas from the exhaust manifold 20, via the second EGR conduit 24. The second EGR conduit 24 is disposed downstream of the exhaust manifold 20 and upstream of the turbocharger 30.

The turbocharger 30 may be a fixed geometry turbocharger or a variable geometry turbocharger (VGT). The turbocharger 30 includes a turbine 36, a compressor 38, an exhaust gas outlet 40, a fresh intake air conduit 42, and a compressed air exit conduit 44. The turbine 36 is rotatably driven by the exhaust gas from the second EGR conduit 24. The exhaust gas, which drives and exits from turbine 36, flows to the environment, via the exhaust gas outlet 40. The turbine 36 includes an output shaft (not shown), which rotatably drives the compressor 38. The compressor 38 is in fluid communication with the fresh intake air conduit 42 and the compressed air exit conduit 44. The compressor 38 receives fresh intake air, via the fresh intake air conduit 42 and upon compression allows a compressed air stream to exit, via the compressed air exit conduit 44. The compressor 38 delivers the compressed air to the aftercooler 34, via the compressed air exit conduit 44.

The aftercooler 34 is positioned downstream of the turbocharger 30 and upstream of the intake manifold 18. The aftercooler 34 cools the compressed air received from the compressor 38. The aftercooler 34 is fluidly connected to the intake air conduit 16. Hence, upon being cooled, the cooled compressed air is delivered to the intake manifold 18, via the intake air conduit 16.

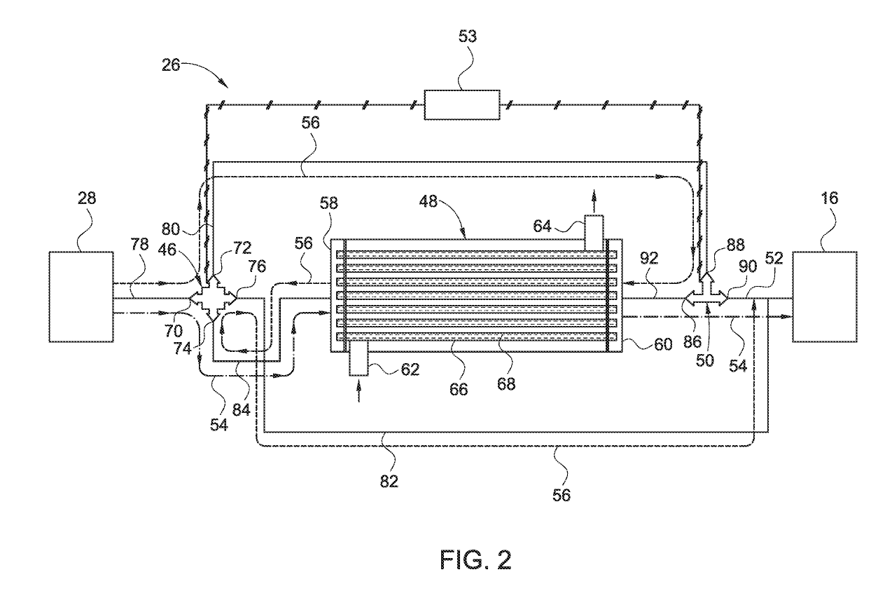

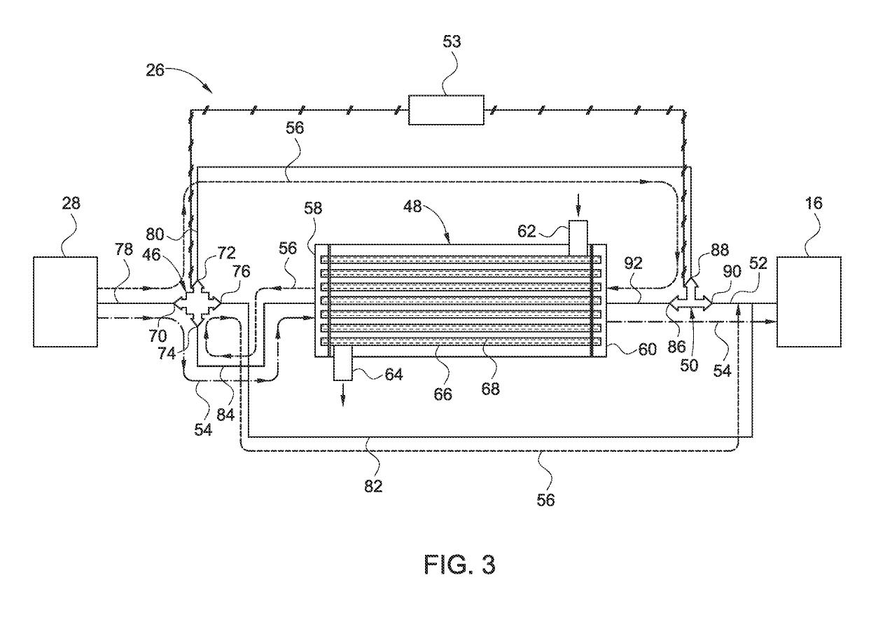

Referring to FIGS. 2 and 3, there is shown the EGR cooler system 26. FIG. 2 shows a first embodiment of the EGR cooler system 26 and FIG. 3 shows a second embodiment of the EGR cooler system 26. Both the embodiments are similar in structure, components, and operation, except for difference in direction of coolant flow, which will be discussed in detail further in the description. The EGR cooler system 26 is disposed downstream of the exhaust manifold 20 and upstream of the intake manifold 18. The EGR cooler system 26 includes a four-way valve 46, an EGR cooler 48, a three-way valve 50, an EGR cooler conduit 52, and a controller 53.

The EGR cooler 48 is disposed between the four-way valve 46 and the three-way valve 50. The EGR cooler 48 is operable selectively in a normal flow state (exhaust stream flow shown as 54) and a reverse flow state (exhaust stream flow shown as 56. In the normal flow state (exhaust stream flow shown as 54), the EGR cooler 48 is fluidly connected to the exhaust manifold 20 and the EGR cooler conduit 52, via the four-way valve 46 and the three-way valve 50, respectively. In the reverse flow state (exhaust stream flow shown as 56), the EGR cooler 48 is fluidly connected to the exhaust manifold 20, serially, via the four-way valve 46 and the three-way valve 50 and is in fluid communication with the EGR cooler conduit 52, via the four-way valve 46. The EGR cooler 48 includes a first end 58 and a second end 60. The first end 58 is disposed proximal to the four-way valve 46. The first end 58 receives the exhaust stream from the four-way valve 46 for cooling, in the normal flow state (exhaust stream flow shown as 54). The first end 58 also allows exit of a cooled exhaust stream, in the reverse flow state (exhaust stream flow shown as 56).

The second end 60 is disposed proximal to the three-way valve 50. The second end 60 receives the exhaust stream from the three-way valve 50 for cooling, in the reverse flow state (exhaust stream flow shown as 56). The second end 60 also allows exit of the cooled exhaust stream, in the normal flow state (exhaust stream flow shown as 54).

Referring to FIG. 2, the EGR cooler 48 includes a coolant inlet 62, a coolant outlet 64, and coolant passages 66. The coolant inlet 62 is disposed at the first end 58 and the coolant outlet 64 is disposed at the second end 60. Referring to FIG. 3, the coolant inlet 62 is disposed at the second end 60 and the coolant outlet 64 is disposed at the first end 58. Referring to FIGS. 2 and 3, the coolant inlet 62 and the coolant outlet 64 are fluidly connected to each other, via the coolant passages 66, attached there between. The coolant passages 66 run inside the EGR cooler 48 and are fluidly connected to the coolant inlet 62 and the coolant outlet 64. The coolant inlet 62 may be in fluid communication with engine coolant passages (not shown) to receive a coolant 68 therefrom. The coolant inlet 62 then facilitates entry of the coolant 68 in the coolant passages 66, which exits the EGR cooler 48, via the coolant outlet 64, upon cooling the exhaust stream. In the disclosed embodiment, the coolant 68 is water.

Referring to FIGS. 2 and 3, the four-way valve 46 is positioned downstream of the EGR valve 28 in the exemplary embodiment, such that the four-way valve 46 is disposed between the EGR valve 28 and the EGR cooler 48. The four-way valve 46 is in fluid communication with the EGR valve 28, and thus receives the metered exhaust gas (as the exhaust stream) from the EGR valve 28. The four-way valve 46 is operable to work in the normal flow state (exhaust stream flow shown as 54) and the reverse flow state (exhaust stream flow shown as 56). The four-way valve 46 includes a first port 70, a second port 72, a third port 74, and a fourth port 76. In every flow state, the first port 70 is in fluid communication the EGR valve 28, via a first passage 78 and receives the exhaust stream. The first port 70 is also selectively in fluid communication with the second port 72 and the third port 74. The second port 72 is selectively in fluid communication with the three-way valve 50, via a second passage 80. The third port 74 is selectively in fluid communication with the first port 70 and the fourth port 76. The fourth port 76 is in fluid communication with the EGR cooler conduit 52, via a fourth passage 82.

In the normal flow state (exhaust stream flow shown as 54), the first port 70 is selected for fluid communication with the third port 74. The third port 74 is in fluid communication with the first end 58 of the EGR cooler 48, via a third passage 84. In the reverse flow state (exhaust stream flow shown as 56), the first port 70 is selected for fluid communication with the second port 72. The second port 72 is in fluid communication with the three-way valve 50, via the second passage 80. The third port 74 is in fluid communication with the second end 60 of the EGR cooler 48, via the third passage 84. In addition, the third port 74 is selected to be in fluid communication with the fourth port 76, which in turn, is in fluid communication with the EGR cooler conduit 52, via the fourth passage 82.

The three-way valve 50 is positioned upstream of the intake air conduit 16 and downstream of the EGR cooler 48, in the exemplary embodiment, such that the three-way valve 50 is disposed between the EGR cooler 48 and the intake air conduit 16. The three-way valve 50 is in fluid communication with the intake air conduit 16, and thus receives the cooled exhaust stream, via the EGR cooler conduit 52. The three-way valve 50 is operable to work in the normal flow state (exhaust stream flow shown as 54) and the reverse flow state (exhaust stream flow shown as 56). The three-way valve 50 includes a first valve port 86, an inlet port 88, and an outlet port 90. The first valve port 86 is in fluid communication with the second end 60 of the EGR cooler 48 and is selectively in fluid communication with the inlet port 88 and the outlet port 90. The inlet port 88 is selectively in fluid communication with the second port 72 of the four-way valve 46, via the second passage 80. In every flow state, the first valve port 86 is in fluid communication with the second end 60 of the EGR cooler 48, via a fifth passage 92. The outlet port 90 is selectively in fluid communication with the intake air conduit 16, via the EGR cooler conduit 52.

In the normal flow state (exhaust stream flow shown as 54), the first valve port 86 is selected for fluid communication with the outlet port 90, which in turn is in fluid communication with the intake air conduit 16, via the EGR cooler conduit 52. In the reverse flow state (exhaust stream flow shown as 56), the inlet port 88 is in fluid communication with the second port 72 of the four-way valve 46, via the second passage 80. Further, the inlet port 88 comes in fluid communication with the first valve port 86.

The controller 53 is adapted to act as a control unit for the locomotive engine system 10 as well. The controller 53 is in control communication with a sensor (not shown), the four-way valve 46, the EGR cooler 48, and the three-way valve 50.

The sensor (not shown is electrically connected with a throttle lever (not shown) The sensor (not shown senses a current throttle position of the locomotive engine 12 and generates a current throttle position signal for the same. The sensor (not shown) sends the current throttle position signal to the controller 53. Based on the current throttle position signal, the controller 53 determines an operating state of the EGR cooler 48. The controller 53 selectively operates the EGR cooler 48 to function in the normal flow state (exhaust stream flow shown as 54) and the reverse flow state (exhaust stream flow shown as 56).

The throttle lever (not shown) controls a speed and power of the locomotive engine 12. The speed and power varies from a minimum speed to a maximum speed, as the current throttle position changes from an idle throttle position and moves up towards throttle positions 1 through 8. It may be contemplated that fouling primarily occurs at low throttle positions, such as the idle throttle position, throttle position 1, throttle position 2, and throttle position 3, because temperature of the exhaust stream is lower at low throttles, resulting in increased content of particulate matter or unburnt hydrocarbons. Moreover, the deposition of particulate matter is favored by a slow flow velocity of the exhaust stream through the EGR cooler 48. Similarly, at high throttle positions, such as throttle position 4 until throttle position 8, there is decreased content of the particulate matter, because of high temperature of the exhaust stream. In addition, due to high flow velocity of the exhaust stream at the high throttle positions, there are less chances of the deposition of the particulate matter in the EGR cooler 48.

As mentioned above, the controller 53 is in control communication with the four-way valve 46 and the three-way valve 50. The controller 53 operates each of the four-way valve 46 and the three-way valve 50, selectively in the normal flow state and the reverse flow state, in order to operate the EGR cooler 48 in the normal flow state and the reverse flow state, respectively. This is done based on the current throttle position as determined by the controller 53.

### INDUSTRIAL APPLICABILITY

In operation, the exhaust stream is diverted from a selected number of cylinders of the locomotive engine 12, via the first EGR conduit 22. The first EGR conduit 22 provides the exhaust stream to the EGR cooler system 26, via the EGR valve 28. Simultaneously, the controller 53 receives the current throttle position signal and determines the current throttle position as a low throttle position signal (preferably one of an idle throttle position signal, throttle position 1 signal, a throttle position 2 signal, and a throttle position 3 signal). Thereafter, the controller 53 determines to operate the EGR cooler 48 in the normal flow state and hence, actuates the four-way valve 46 and the three-way valve 50 to operate in the normal flow state.

In the normal flow state (exhaust stream flow shown as 54), the metered amount of the exhaust stream flow from the EGR valve 28 to the first port 70 of the four-way valve 46. The first port 70 directs the exhaust stream to exit the four-way valve 46, via the third port 74. From the third port 74, the exhaust stream enters the first end 58 of the EGR cooler 48, via the third passage 84. While passing through the EGR cooler 48, the exhaust stream is cooled by action of the coolant 68 flowing through the coolant passages 66. Upon being cooled, the cooled exhaust stream exits the EGR cooler 48, via the second end 60. When the EGR cooler 48 is operated for a duration of time in the normal flow state (exhaust stream flow shown as 54), particulate matter in the exhaust stream tend to accumulate at the second end 60 and form a thick layer of particulate matter deposit. This leads to fouling and hence, inefficiency of the EGR cooler 48. After exiting the EGR cooler 48, the cooled exhaust stream flows to the first valve port 86 of the three-way valve 50 and exits the same, via the outlet port 90. From the outlet port 90, the cooled exhaust stream flows to the EGR cooler conduit 52, which merges with the intake air conduit 16. Hence, the cooled exhaust stream then flows to the intake air conduit 16, and thereafter enters the intake manifold 18.

When the controller 53 receives the current throttle position signal that corresponds to a high throttle position (preferably a throttle position 4 signal and above), the controller 53 determines to switch the operating state of the EGR cooler system 26 to the reverse flow state (exhaust stream flow shown as 56). Accordingly, the controller 53 actuates the four-way valve 46 and the three-way valve 50 to operate in the reverse flow state. The reverse flow state serves the purpose of removal of the particulate matter. In the reverse flow state (exhaust stream flow shown as 56), the exhaust stream from the EGR valve 28 enters the first port 70 and navigates to exit, via the second port 72. The second port 72 allows flow of the exhaust stream to the second passage 80. Thereafter, the exhaust stream enters through the inlet port 88 of the three-way valve 50 and exits, via the first valve port 86. After exiting the first valve port 86, the exhaust stream enters the EGR cooler 48, via the second end 60. Due to the high throttle position, when the exhaust stream at the high flow velocity, disintegrates a substantially loose layer of the particulate matter deposit at the second end 60. Further, the exhaust stream is hot enough to combust most of the remaining portion of the particulate matter deposit. In addition, when the exhaust stream exits the EGR cooler 48 from the first end 58, a portion of the particulate matter in the exhaust stream tend to accumulate at the first end 58.

The disclosed EGR cooler system 26 is advantageous over existing EGR coolers, as during servicing the existing EGR coolers are required to be removed and cleaned. Hence, the disclosed EGR cooler system 26 provides a time saving way of cleaning the EGR cooler 48, without disrupting the operation of cooling of the exhaust stream. With inclusion of mechanical components, the disclosed EGR cooler 48 is cost effective and easy to maintain. Additionally, the controller 53 automates the self-cleaning EGR cooler system 26 to change the operating state based upon the current throttle position of the throttle lever (not shown). The disclosed throttle-based EGR cooler system 26 is independent of the fouling of the EGR cooler 48 and hence it does not allow the cooler to lose its effectiveness over a time period. In a throttle based flow reversal method actuated by the disclosed EGR cooler system 26, the engine performance is consistent since the fouling in the EGR cooler 48 is minimal. It is important for the engine to perform at the same operating efficiency for a longer time period, in order to meet the emission requirements. In addition, alternating operation of the disclosed EGR cooler system 26 between the normal flow state and the reverse flow state facilitates self-cleaning of the four-way valve 46 and the three-way valve 50.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A self-cleaning exhaust gas recirculation (EGR) cooler system of a locomotive engine, the self-cleaning EGR cooler system comprising:
an EGR cooler disposed downstream of an exhaust manifold, wherein the EGR cooler includes a first end and a second end to selectively allow entry of an exhaust stream into the EGR cooler;
a four-way valve fluidly connected to the exhaust manifold and the EGR cooler, the four-way valve including a first port, a second port, a third port, and a fourth port, the first port being fluidly connected to the exhaust manifold to receive the exhaust stream, the first port is selectively in fluid communication with the second port and the third port, the third port is selectively in fluid communication with the first port and the fourth port, the fourth port is fluidly connected to an intake air conduit;
a three-way valve positioned downstream to the EGR cooler and upstream of the intake air conduit and fluidly connected to the four-way valve, the three-way valve including a first valve port, an inlet port, and an outlet port, the first valve port being in fluid communication with the second end of the EGR cooler, the first valve port is selectively fluidly connected to the inlet port and the outlet port, the inlet port is in fluid communication with the second port of the four-way valve, the outlet port is in fluid communication with the intake air conduit; and
a controller in control communication with the four-way valve and the three-way valve, the controller adapted to operate the four-way valve and the three-way valve selectively in a normal flow state and a reverse flow state based on a current throttle position of the engine, to correspondingly operate the EGR cooler in the normal flow state and the reverse flow state, respectively,
wherein in the normal flow state the exhaust stream from the exhaust manifold flows through the first port and the third port of the four-way valve, enters the EGR cooler via the first end and exits through the second end, thereby resulting in particulate matter deposit at the second end, the exhaust stream downstream of the EGR cooler enters the three-way valve via the first valve port and exits via the outlet port and flows to the intake air conduit,
wherein in the reverse flow state the exhaust stream from the exhaust manifold flows through the first port and the second port of the four-way valve and navigates to the inlet port and exits via the first valve port of the three-way valve, the exhaust stream then enters through the second end thereby removing the particulate matter deposit at the second end, and exits via the first end, the exited exhaust stream is navigated to the intake air conduit via the third port and fourth port of the four-way valve.
